(19) United States
(12) Patent Application Publication
(10) Pub. No.: US 2003/0088564 A1
(43) Pub. Date: May 8, 2003

(54) Method for determining a complex correlation pattern from method data and system data

(76) Inventors: Bernd Lohmann, Bergisch Gladbach (DE); Andreas Schuppert, Kurten (DE); Jens Kampfer, Koln (DE); Michael Warncke, Koln (DE)

Correspondence Address: BAYER POLYMERS LLC, 100 BAYER ROAD, PITTSBURGH, PA, 15205, US

(21) Appl. No.: 10/269,707

(22) Filed: Oct. 11, 2002

(30) Foreign Application Priority Data
Oct. 17, 2001 (DE) 10151250.3

(51) Int. Cl. G06F 7/00

(52) U.S. Cl. 707/6

(57) ABSTRACT

The invention relates to a method for determining a complex correlation pattern composed of method data and system data, preferably of an industrial database, having the following steps:

a) assigning a matrix element to an element of a system and specifying a corresponding property in a matrix,

b) generating the matrix by means of a database query,

c) detecting the complex correlation pattern in the matrix automatically.

### FIELD OF THE INVENTION

The invention relates to a method for determining a complex correlation pattern from method data and system data and a corresponding computer system and computer program product.

### BACKGROUND OF THE INVENTION

Various methods for processing and displaying complex information relating to a manufacturing process, in particular an industrial process, are known. In this context, this information is generally stored in databases, for example data warehouse databases.

U.S. Pat. No. 6,243,615 discloses a system for analyzing and improving pharmaceutical and other capital-intensive manufacturing methods. In this context, a statistical software tool is used to identify the cause of inadequate product quality.

U.S. Pat. No. 5,768,133 discloses the use of a data warehouse computer system for controlling a semiconductor manufacturing plant. The data relating to the sequences of the semiconductor manufacture is stored in a central data warehouse database and evaluated appropriately. The data warehouse database can be accessed interactively by means of a graphic user interface.

U.S. Pat. No. 5,721,903 discloses a system for generating a report from a data warehouse computer database. During this, user queries are interpreted by a subsystem and mapped onto a structured query language (SQL) query. A respective database query thus provides a user with a decision aid in relation to business sequences without the user having to know the details of the database.

For what is referred to as “decision support”, OLAP (Online Analytical Processing) databases are known which also in particular permit a multivariant data analysis. Such databases are known, for example, from U.S. Pat. No. 6,205,447, U.S. Pat. No. 6,122,636, U.S. Pat. No. 5,974,788, U.S. Pat. No. 5,940,818 and U.S. Pat. No. 5,926,818.

In addition, what are referred to as industrial data models and industrial development environments are known from the prior art, cf. B. Bayer, R. Schneider, W. Marquardt, “A Conceptual; Framework for Product Data Models”, VDI/VDE-Gesellschaft Mess- und Automatisierungstechnik (eds.): “Automatisierungstechnik im Spannungsfeld neuer Technologien” [VDI/VDE-Society for Measurement and Automation Technology (eds.): “Automation Technology Applied in Problem Areas of New Technologies]”, VDI report 1608, VDI-Verlag [publishing house], 2001, 681-688 and R. Bogusch, B. Lohmann, W. Marquardt: Computer-Aided Process Modeling with MODKIT, abstract can be called at http://www.Ifpt.rwth-aachen.de/Publication/Techreport/.

### SUMMARY OF THE INVENTION

The invention is based on the object of providing a method for determining a complex correlation pattern of method data and system data and a corresponding computer system and computer program product.

The object on which the invention is based is respectively achieved with the features of the independent patent claims.

### BRIEF DESCRIPTION OF THE DRAWINGS

FIG. 1 shows a flowchart of an embodiment of the method according to the invention,

FIG. 2 shows an example of a cross matrix,

FIG. 3 shows a block diagram of an embodiment of a computer system according to the invention,

FIG. 4 shows an exemplary structure of a project of an industrial database,

FIG. 5 shows a user interface of an explorer program,

FIG. 6 shows a dialogue window for processing apparatus data,

FIG. 7 shows a block diagram of a plant with various subplants for manufacturing a chemical product,

FIG. 8 shows a detail of the structure of a respective project,

FIG. 9 shows a cross matrix for a correlation and control analysis relating to the example in FIG. 1,

FIG. 10 shows the graphic representation of the relationships which are discovered,

FIG. 11 shows the textual outputting of the relationships which are discovered,

FIG. 12 shows the graphic representation of the relationships which are discovered with respect to method variant 2,

FIG. 13 shows the textual outputting of the relationships which are discovered with respect to method variant 2,

FIG. 14 shows an overview representation of the method sequence.

### DETAILED DESCRIPTION OF THE INVENTION

Preferred embodiments of the invention are given in the dependent patent claims.

The present invention permits complex correlation patterns to be detected in method data and system data, for example data of one or more chemical fabrication plants, by means of an automatic method. For this purpose, a user-defined matrix in which each matrix element is assigned to a specific method and a specific system as well as to a corresponding property is first specified. The assignment can be made here, for example, to different apparatuses of the same plant or to corresponding apparatuses of different plants and to a physical property, for example pressure, temperature and concentration. The matrix can be a cross matrix of any dimensions.

In addition to physical properties, industrial properties, in particular costs, and quality properties can also be assigned. The properties and the plant elements are selected here in each case in accordance with the data aspect which is relevant to the users question.

In one preferred embodiment of the invention, the data warehouse is based on an object-oriented data model, which, in particular, links the following objects: projects, project variants, simulations, implementations, material data and/or design data to one another.

The database is preferably stored on a server computer which a client computer accesses. An explorer program of the client computer can be used to interrogate from the database the data which is necessary to generate the matrix and to store it in a memory of the client computer. Dynamic updating can also be carried out by cyclic interrogation of the data via the explorer.

According to the invention, different methods can be applied for automatically detecting complex correlation patterns in the matrix. For example cluster methods, decision trees, subgroup search, fuzzy logic and rough sets methods are suitable for this.

U.S. Pat. No. 6,112,194, U.S. Pat. No. 6,115,708, U.S. Pat. No. 6,100,901 and U.S. Pat. No. 5,857,179 disclose cluster methods, in particular for data mining applications. Such cluster methods, and others, can be applied for identifying complex correlation patterns in a method according to the invention.

A preferred exemplary embodiment of the invention is explained in more detail below with reference to the drawings, in which:

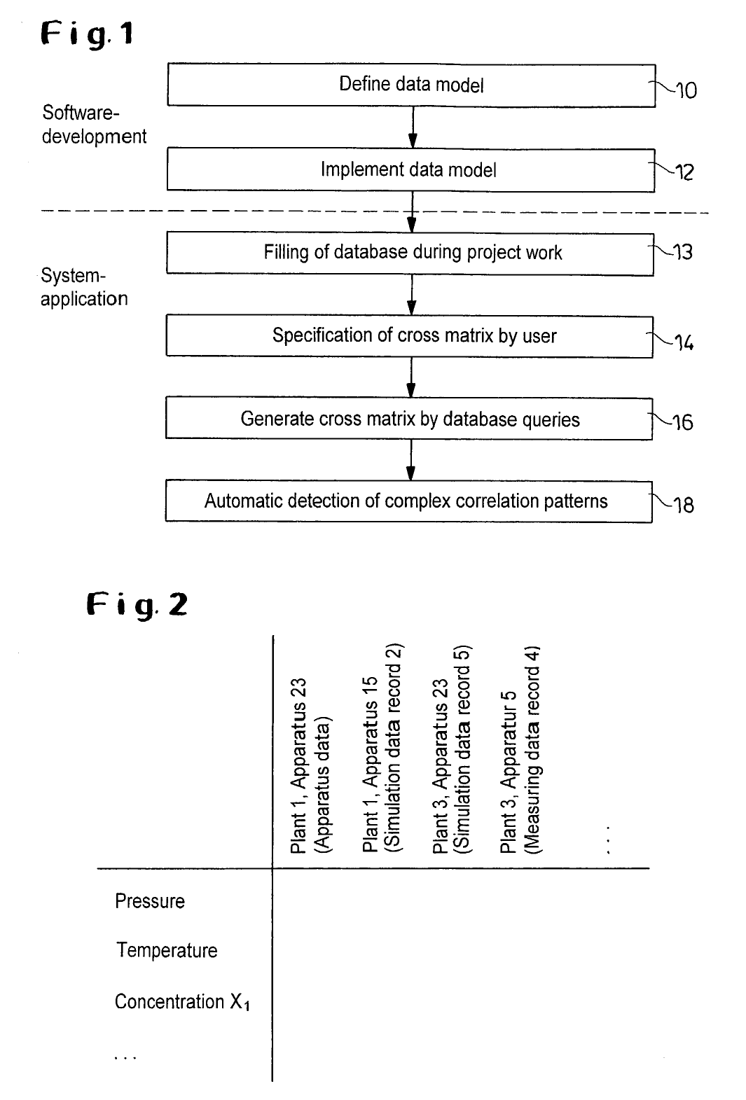

FIG. 1 shows a flowchart of an embodiment of the method according to the invention,

FIG. 2 shows an example of a cross matrix,

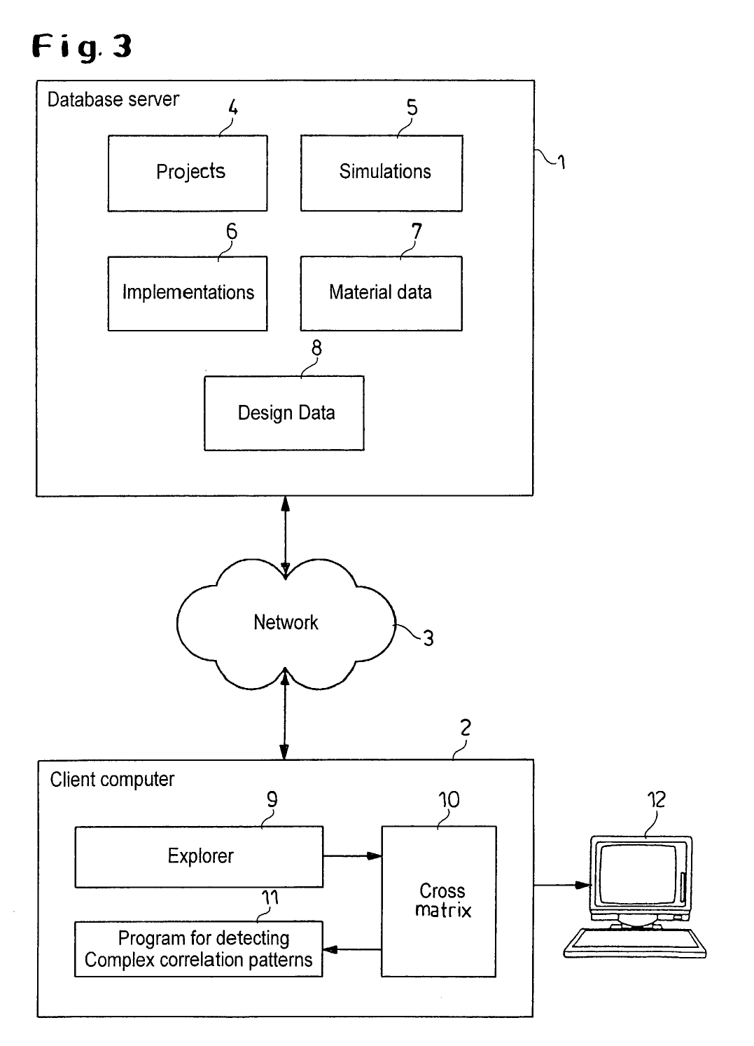

FIG. 3 shows a block diagram of an embodiment of a computer system according to the invention,

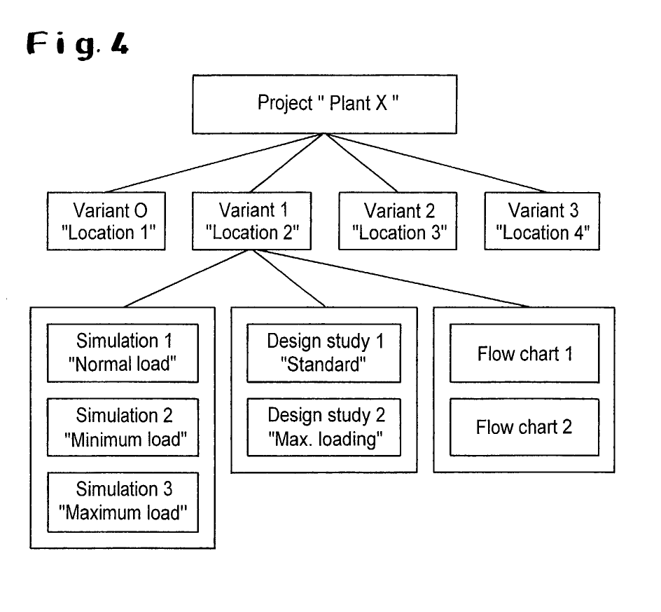

FIG. 4 shows an exemplary structure of a project of an industrial database,

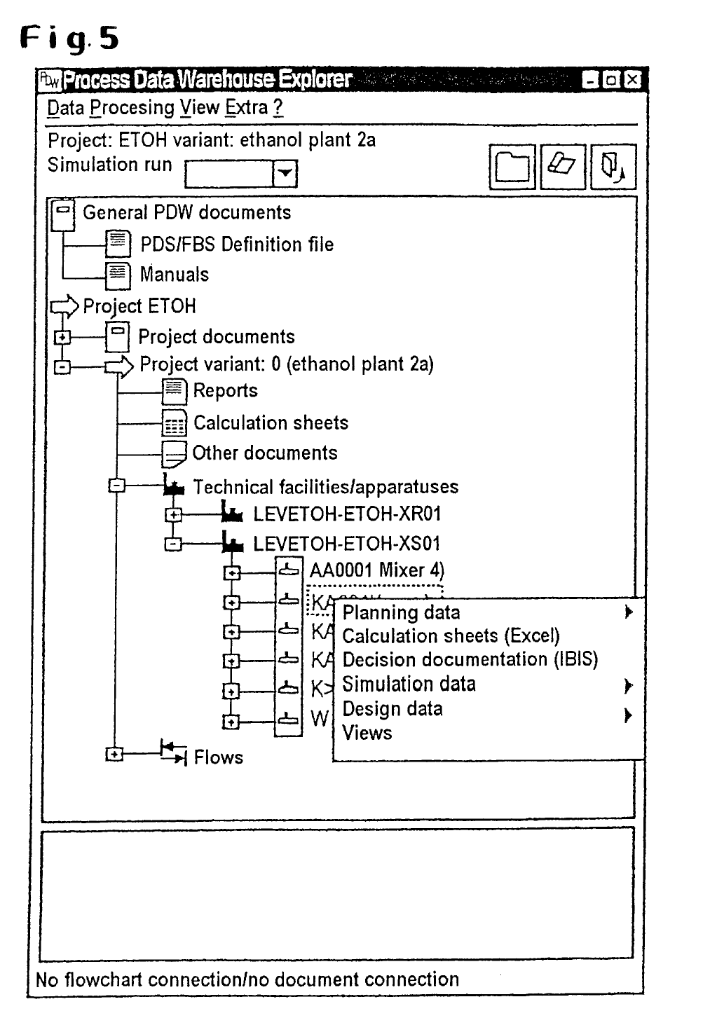

FIG. 5 shows a user interface of an explorer program,

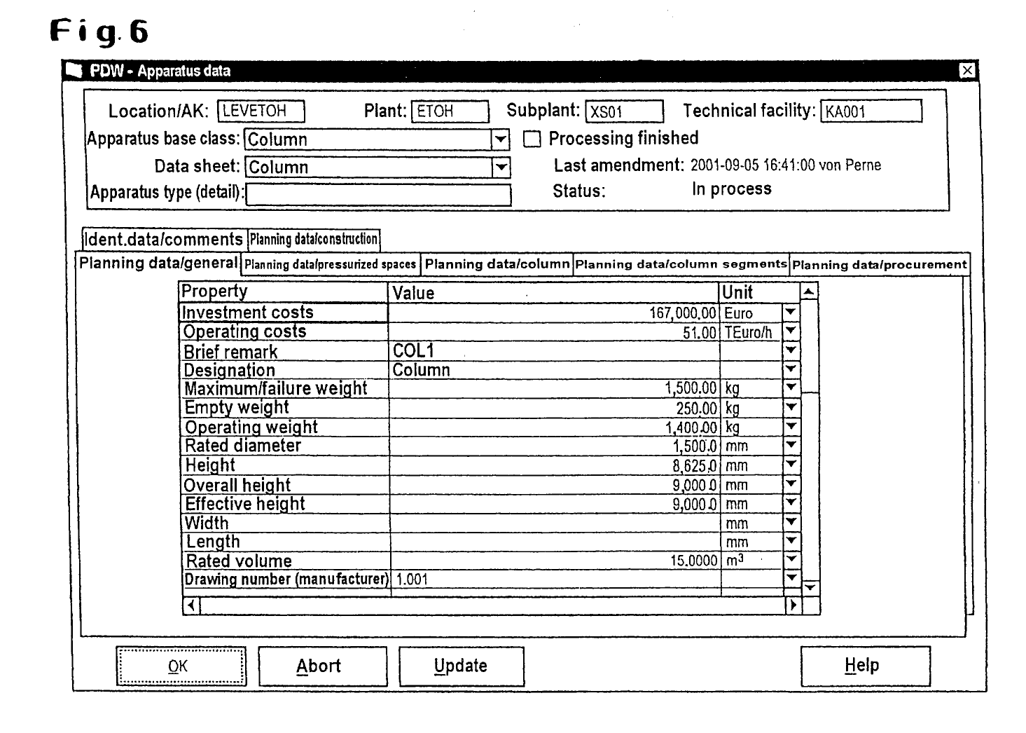

FIG. 6 shows a dialogue window for processing apparatus data,

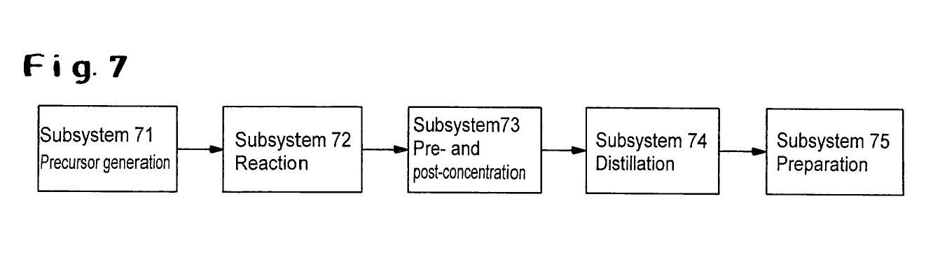

FIG. 7 shows a block diagram of a plant with various subplants for manufacturing a chemical product,

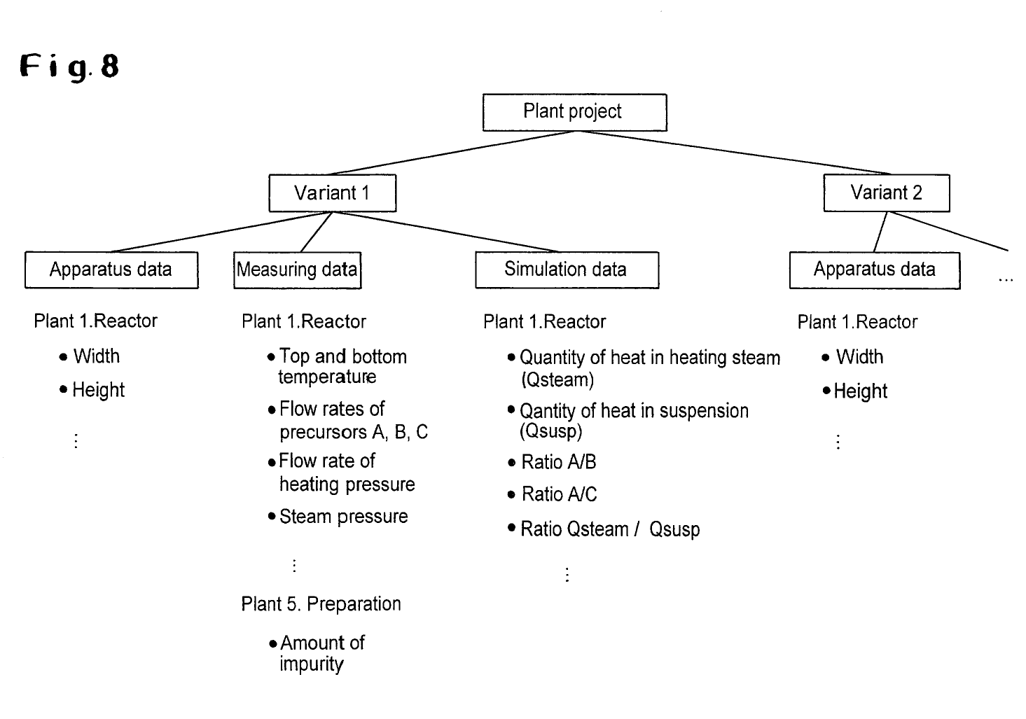

FIG. 8 shows a detail of the structure of a respective project,

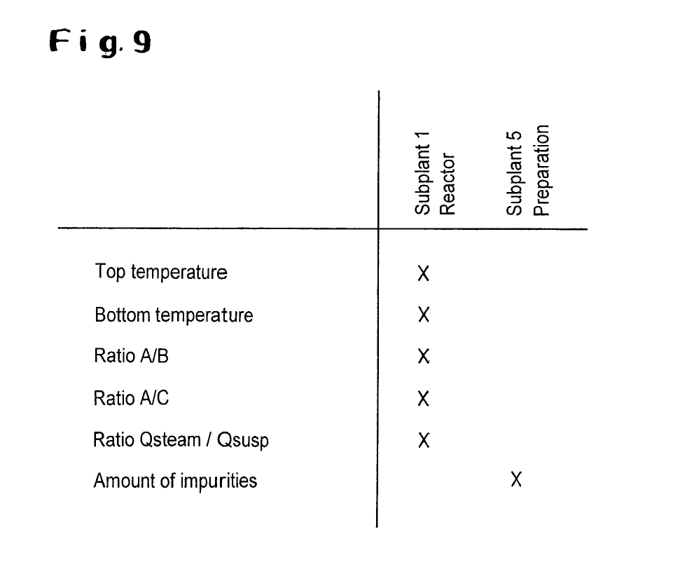

FIG. 9 shows a cross matrix for a correlation and control analysis relating to the example in FIG. 1,

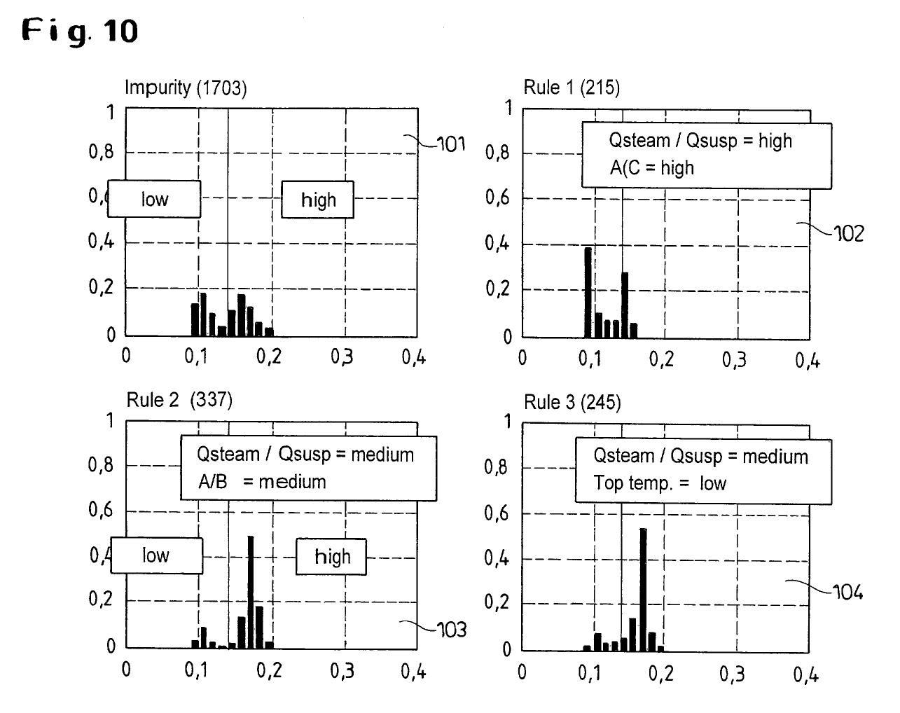

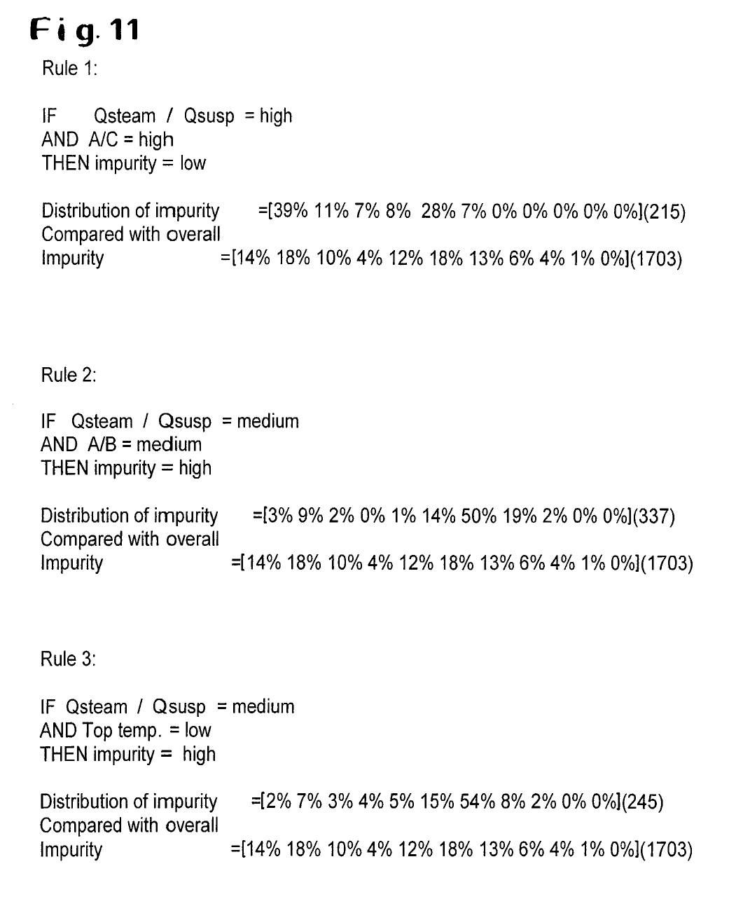

FIG. 10 shows the graphic representation of the relationships which are discovered,

FIG. 11 shows the textual outputting of the relationships which are discovered,

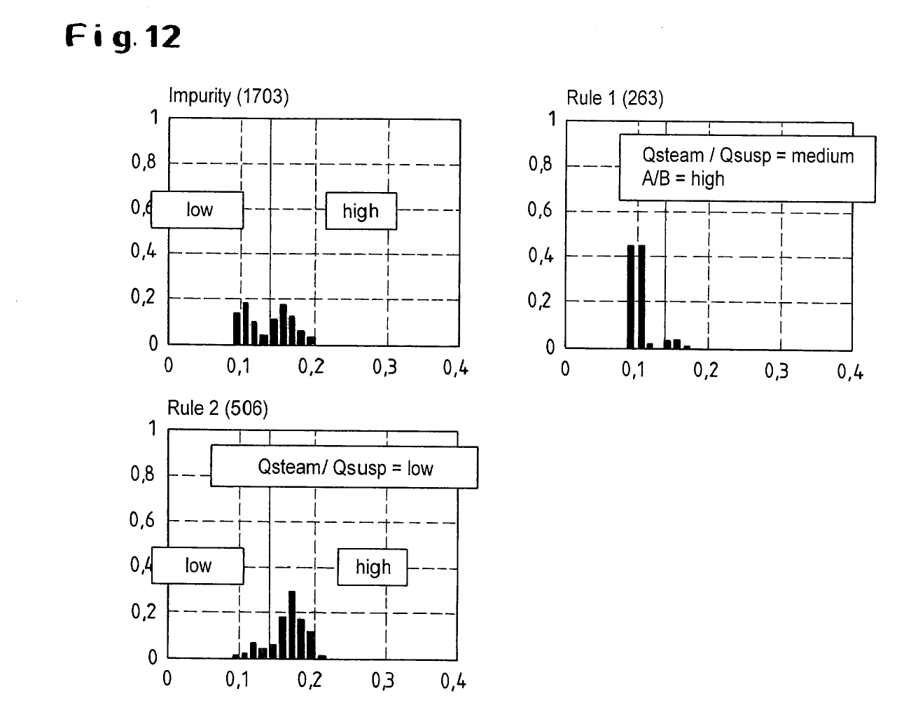

FIG. 12 shows the graphic representation of the relationships which are discovered with respect to method variant 2,

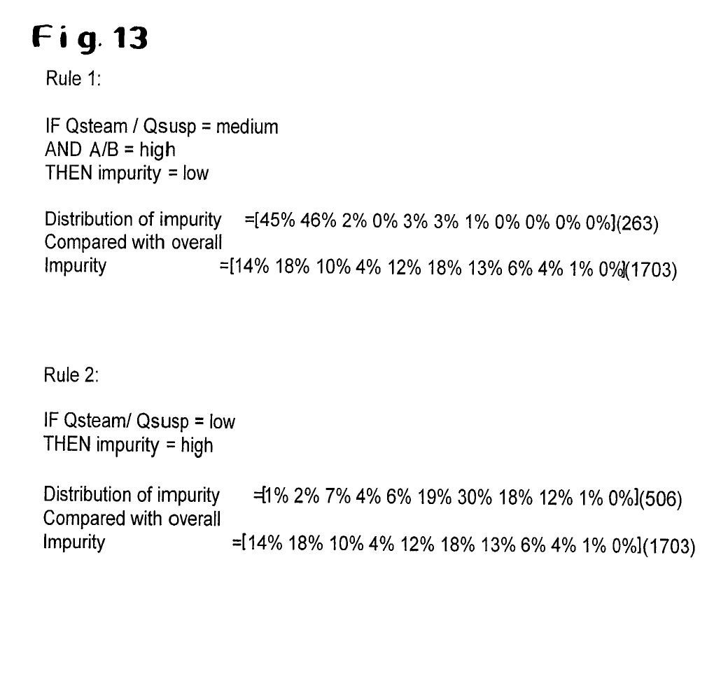

FIG. 13 shows the textual outputting of the relationships which are discovered with respect to method variant 2,

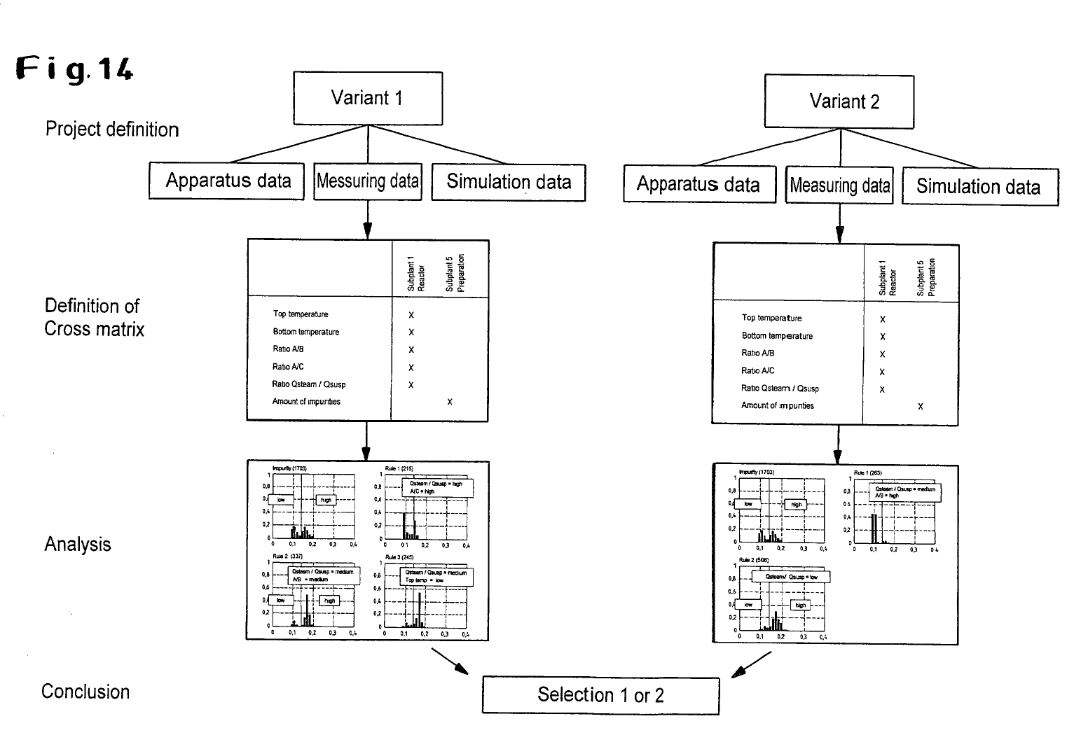

FIG. 14 shows an overview representation of the method sequence.

According to the flowchart in FIG. 1, a data model, for example an object-oriented data model, of the respective plant or of the respective group of plants is generated in step 10. The plants can be, for example, chemical fabrication plants for a specific product, which are either already in existence or for which planning data (for example simulation data, apparatus data, flowcharts etc.) are available or can be produced.

In addition, the data model can also be the mapping of different method variants for manufacturing the same chemical product on the same plant.

In step 12, a database is implemented based on the data model defined in step 10. This database is then filled with data in step 13. To do this, for example data, design and/or simulation data which are determined by measuring are used. Then, this database is available for user's applications.

In step 14, a user specifies a matrix in order to link variables contained in the database to one another, depending on the user's question. Such a matrix may have two dimensions or more, for example a chronological profile can be selected as a third dimension. FIG. 2 illustrates an example of such a cross matrix which will be explained in more detail below.

In step 16, the matrix specified in step 14 is filled with data in that a database query is carried out for the individual matrix elements of the matrix.

The matrix generated in step 16 is the basis for the further evaluation.

In step 18, a method for determining a complex correlation pattern is applied to the matrix. This can be, for example, a cluster method or some other statistical or pattern detection method. Here, relationships are determined between the data of the matrix and output as rules, for example.

FIG. 2 shows an example of such a matrix. The matrix logically links the physical variables of pressure, temperature and concentration to different apparatuses, at various plants; in the examples shown these are the apparatus 23 of plant 1, apparatus 15 of plant 1, apparatus 23 of plant 3 and apparatus 5 of plant 3. Here, the respective type of data in question is also specified in the matrix.

In the case of apparatus 23 of plant 1, the data is therefore apparatus data which can be obtained from a stored apparatus data sheet (cf. FIG. 7) from the database. In contrast, the corresponding data for the apparatus 15 of plant 1 is data which has been calculated by a simulation—by a simulation data record 2 in the example shown.

The same applies to the data for the apparatus 23 of plant 3 which is obtained by means of a simulation data record 5. The data for the apparatus 5 of plant 3 is finally determined by measuring and can be called from a measuring data record 4.

Using such a matrix, it is therefore possible to relate individual simulation data items of a simulation data record to individual apparatus data items and measuring data items. If required, the necessary calculation formulae can also be mapped here at the same time.

Analogously, measuring data can also be related to simulation data and apparatus data. This can be carried out by means of a manual assignment by a user. Alternatively, or in addition, one or more alternative, predefined relations for specifying a matrix can also be offered to the user for selection.

It is a particular advantage here that design and simulation studies can be compared both with one another and with apparatus data. Thus, both already existing plants and plants during planning can be compared with one another, and existing plants can also be compared with plants which are only available as simulation.

In addition, different methods for manufacturing the same product can be compared with one another in that, for example, the method data items can be compared with one another when the different methods are carried out on the same plant or similar plants.

In addition, in this way it is possible to compare simulation data records, measuring data records and apparatus data records, specifically within one data record group and also intermediate data record groups.

A matrix can advantageously be specified in what is referred to as a spread sheet, the user being able to define the rows and columns himself. Once a matrix has been specified in such a way, it can be stored as a template for later re-use in another context.

If the matrix has been generated by a database query, the matrix can be dynamically updated, for example by means of cyclically repeated database queries.

FIG. 3 shows a block diagram of a computer system with a database server 1 and a client computer 2 which are connected via a network 3.

The database server 1 contains a database with method data and system data. The database is based on an object-oriented data model with the following objects: projects 4, simulations 5, implementation 6, material data 7 and design data 8. This implements an industrial database.

All the essential information relating to a project is stored in the industrial database in a “file” which is referred to as a project. A plurality of what are referred to as variants can be defined for each project 4. These are generally method variants.

A plurality of simulations 5 can be defined for each variant. For example, the user can store simulations 5 for the minimum load, maximum load or normal load of a plant in the industrial database.

In addition, the industrial database enables a range of variants to be mapped, for example to maintain various design studies for a method variant (design data 8). These always relate to an individual apparatus or an individual planning object 4. In order to display data, a plurality of flowcharts can be stored in the industrial database for each variant.

In the data model of the industrial database, a project 4 or one of its alternatives by means of which the mapping of the method alternatives is carried out each constitutes a logic unit. As a rule, a project alternative is graphically represented in one or more flowcharts, apparatuses, flows, value fields, measuring points and annotations being assigned to symbols in the flowchart. Moreover, apparatus and mass flow lines can also be represented on a flowchart. Mass flow lines can also relate to a specific simulation 5.

In particular, a project 4 has the purpose of mapping a planned or existing plant by means of apparatus data, simulations 5 and design data 8 stored in the implementations 6. The material data 7 contains, inter alia, the physical characteristic variables, necessary for a simulation, of the substances and materials to be used.

In order to determine a complex correlation pattern, the user of the client computer 2 first specifies a corresponding matrix. This can be done by selecting a matrix from a predefined set of matrix templates or by means of specific definitions of a matrix. Using the explorer 9 of the client computer 2, the data is retrieved on an element basis by the industrial database of the database server 1 in order to generate the matrix. The matrix is stored in the memory of the database server 1 by the explorer 9.

After the matrix 10 has been completely generated, a program 11 for detecting complex correlation patterns is started. The results of the execution of the program 11 are output on a screen 12. This can be carried out in a graphically prepared form or textually in the form of rules or the like.

FIG. 4 shows by way of example the structure of a project 4 (cf. FIG. 3). A range of variants 0 to 3 are assigned to a project “Plant X” at various locations 1 to 4. Here, one or more simulations, design studies and/or flowcharts are stored for each variant. This is represented for the variant 1 at the location 2 in FIG. 4:

For the variant 1 there are simulations for “normal load”, “minimum load” and “maximum load” as well as the design data for the “standard” load case and “maximum loading”. In addition, two different flowcharts are stored for the variant 1.

FIG. 5 shows a window of the explorer program 9. The explorer shows the project structure in a hierarchy fashion. In addition, all the functionalities for data processing are stored in the explorer. The apparatus-specific and flow-specific context menus can be called when there are marked apparatus names or flow names in the explorer.

FIG. 6 shows an input window for inputting apparatus data. The background is that the industrial database administers not only simulation data, i.e. results of different simulation programs, and design studies, but also what are referred to as planning objects. These are inter alia apparatuses and pipelines. The following apparatus types are supported, for example, by the industrial database:

a) general apparatuses/machines

b) vessels

c) reactors in general

d) precipitator, filter, sieve

e) column

f) motor

g) pump

h) impeller type mixer, agitator

i) centrifuge

j) compressor

k) heat exchanger

l) comminution machine.

For each apparatus, various attributes are defined which can be input and/or modified in what is referred to as an apparatus data dialogue according to the input window in FIG. 6.

Certain apparatuses such as columns have a substructure which is used to specify column bases, packages or particular installations.

Furthermore, data sheets for planning objects can be stored in order to perform a detailed specification. By means of a corresponding input window it is possible to input the data of a data sheet, i.e. operating data, execution data (piston shape etc.) and further data for, for example, a rotary piston pump with shaft seal. The individual data items of the data sheet can be input manually by the user or imported from other systems.

In the industrial database, the data elements for an apparatus are administered in the form of detail data and dynamic attributes. The structure of detail data and dynamic attributes is the same: they can be freely configured by assigning a name, a data type and, if appropriate, a predefined value list to each data element. A classification system is used for grouping data elements. While detail data is predefined for the various apparatus types in the industrial database, dynamic attributes can also be created by the user when necessary.

The industrial database also supports a detailed structuring of apparatuses by means of relations. The relatedness of various apparatuses and subcomponents of a system can thus be described. For example: a specific reactor is composed for example of a vessel and two heat exchangers; a column has a number of different segments; a vessel has one or more agitators which in turn have motors etc.

The results of the simulation of entire plants or subplants can be stored in the industrial database and assigned to the real apparatuses. On the one hand, models of the simulated apparatuses and on the other hand mass flows, heat flows and power flows are described. Furthermore, detailed information on the materials contained and the reactions which take place is stored for mass flows.

FIG. 7 shows a plant with the subplants 71, 72, 73, 74 and 75. The plant is used to manufacture a specific chemical product. The chemical product is generated in a reactor using a chemical reaction from three different feed materials (precursors), which are referred to below as A, B and C. These precursors are partially generated in preceding reaction steps. The actual reaction is followed by a plurality of method steps in order to free the product of undesired byproducts and impurities. These are the preconcentration and post-concentration, distillation and preparation of the product.

The subsystem 71 is used for generating precursors, the subsystem 72 for carrying out the actual reaction, the subsystem 73 for the preconcentration and post-concentration, the subsystem 74 for distillation and the subsystem 75 for preparation of the product.

The individual subsystems are themselves in turn composed of a plurality of different apparatuses (reactor, column, condenser, pump etc.).

In the application example of the invention under consideration here, an attempt will be made to examine the influence of the process parameters of the individual apparatuses, in particular of the reactor of subsystem 72, on the quality of the product. Here, a comparison will be made between two different variants of the reactor which differ in height and diameter.

The respective variants are partially illustrated in FIG. 8. The variant 1 of the plant project includes apparatus data, measuring data and simulation data. The results are the corresponding data for the variant 2.

Both apparatus data such as width and height and measuring data such as top temperature and bottom temperature, flow rates of the precursors, flow rate and steam pressure of the heating steam and further measuring data are available for the reactor. In the preparation part of the plant, there is measuring data for the amount of impurities in the end project (cf. FIG. 8).

Using simulation calculations, new data is generated from the existing measuring data and apparatus data of the reactor and, in the present case, advantageously proves to be additional influencing variables in the correlation and control analysis. These variables are the quantity of heat of the heating steam (Qsteam), quantity of heat of the suspension (Qsusp) and the ratios

flow rate of precursor A/flow rate of precursor B (referred to below in abbreviated form as A/B),

flow rate of precursor A/flow rate of precursor C (referred to below in abbreviated form as A/C), and

quantity of heat of heating steam/quantity of heat of suspension (referred to below in abbreviated form as Qsteam/Qsusp).

The detail of the structure of the project is illustrated in FIG. 8. The variant 2 differs from variant 1 in having different values for the apparatus data, measured values and simulation data.

In the present application example, the cross matrix given in FIG. 9 is defined in order to carry out the complex correlation and control analysis. Using an automatic rule search method (subgroup search), new relationships between the selected influencing variables (top temperature, bottom temperature, ratio A/B, ratio A/C, ratio Qsteam/Qsusp) and the selected target variable (quantity impurities) are to be discovered.

The correlation and control analysis with the given cross matrix is carried out here in parallel for the two method variants in order to cover possible differences in the project quality as a function of the reactor geometry.

The relationships which are discovered can be output both in textural and graphic form (cf. FIG. 10 and FIG. 11).

The graphics 101 of FIG. 10 shows the histogram of the quality variable for the method variant 1. The distribution between low and high quality values taking into account all the data records is approximately the same in this case. In the present example, values of less than or equal to 0.14 are considered low levels of impurities and values greater than 0.14 are considered high levels of impurities. This threshold value can be varied by the user as desired.

The correlation patterns discovered for method variant 1 by the automatic rule search (subgroup search) are represented in the graphics 102 to 104. Significant shifts in the quality variable in the low or high value range are found for specific combinations of the input variables.

For example, rule 3 says that, given an average ratio of the quantities of heat (Qsteam to Qsusp) and an average ratio of the flow rates A to B, almost exclusively high levels of impurities are to be expected. The values given in the brackets relate here in each case to the number of data records covered by the rule.

An equivalent textual description of the rules which are found is mapped in FIG. 11. Here, a classification of the target variable into “low” and “high” has already been performed in accordance with the specified threshold value.

FIG. 12 and FIG. 13 show the corresponding results for the method variant 2 in which the reactor geometry, i.e. the height and width of the reactor, was changed in comparison to variant 1.

Conclusions can then be drawn at the suitable reactor geometry from the comparison of the various correlation patterns and rules for the two method variants. In the present case, the selection could be made, for example, in favour of reactor variant 2 as with said variant a good product quality (i.e. few impurities) with low energy expenditure can be produced in comparison to reactor variant 1.

The processing workflow for automatic rule search and determination of complex correlation patterns is illustrated in the form of an overview in FIG. 14. First, a project definition with various project variants, therefore, takes place. This can take place, for example, in the form corresponding to FIG. 8. A cross matrix which, for example, links specific measuring data items with various subsystems of the respective variant is then defined for each of the variants of the project. The cross matrix is then subjected to automatic analysis which reveals specific relationships between the elements of the cross matrix, for example in the form of rules. This comparison of the rules can then enable the variant which is most favourable for the respective application case to be selected.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims

What is claimed is:

1. A method for determining a complex correlation pattern comprising method data and system data having the following steps:
a) assigning a matrix element to an element of a system and specifying a corresponding property in a matrix,
b) generating the matrix by means of a database query,
c) detecting the complex correlation pattern in the matrix automatically.

2. A method according to claim 1, wherein the method data and system data contain data from at least a first system and a second system, and each matrix element is assigned to one of the systems.

3. A method according to claim 2, wherein each matrix element is assigned to an apparatus of a system.

4. A method according to claim 1, wherein the property is a physical property.

5. A method according to claim 1, wherein the property is an economic property.

6. A method according to claim 1, wherein the property is a quality property.

7. A method according to claim 1, wherein the matrix is embodied as a cross matrix.

8. A method according to claim 1, wherein the database is embodied as an OLAP database.

9. A method according to claim 1, wherein the database is based on a data model which links a group of entities to one another, wherein said entities are projects, simulations, implementations, material data, or design data.

10. A method according to claim 1, wherein the database is stored on a database server, and the database query for generating the matrix is made by a client computer, an explorer program or a graphic representation.

11. A method according to claim 1, wherein dynamic updating of the method data and system data are stored in the database.

12. A method according to claim 1, wherein automatic detection of correlations is selected from the group consisting of at least one of the following methods: cluster methods, decision trees, subgroup search, fuzzy logic, rough sets.

13. A method according to claim 1, wherein, as a result of the automatic detection of complex correlations, a rule is output.

14. A method according to claim 1, wherein, as a result of the automatic detection of complex correlations, a correlation between similar systems and/or similar methods on the same system is output.

15. A method according to claim 1, wherein automatically detected complex correlations are graphically outputted.

16. A method according to claim 5, wherein said economic property is costs.

17. A method according to claim 10, wherein said graphic representation, is a flowchart, which is used on the client computer.

18. Computer program product with computer-readable program means for carrying out a method according to claim 1.

19. Computer system having means for executing the steps of a method according to claim 1.

20. Computer system according to claim 18, comprising a database server computer for storing the database and a client computer for accessing the database server computer, wherein the client computer comprises an explorer program for generating the matrix and a memory for storing the generated matrix, as well as a program for detecting complex correlation patterns, wherein said program can access the memory.

21. Computer system according to claim 19, wherein said computer system is a client computer system.
